(19) United States
(12) Patent Application Publication
(10) Pub. No.: US 2025/0342603 A1
(43) Pub. Date: Nov. 6, 2025

(54) DETECTING GROUND PLANE IN THREE-DIMENSIONAL IMAGE

(71) Applicant: Analog Devices International Unlimited Company, Limerick (IE)

(72) Inventors: Prasanna Bhat, Siddapura (IN); Anil M. Sripadarao, Bangalore (IN); Rajesh Mahapatra, Bangalore (IN)

(21) Appl. No.: 18/654,779

(22) Filed: May 3, 2024

(51) Int. Cl. G06T 7/521; G06T 3/40; G06T 3/60; G06T 7/73

(52) U.S. Cl. CPC G06T 7/521; G06T 3/40; G06T 3/60; G06T 7/73; G06T 2207/10028

(57) ABSTRACT

A system for determining a ground plane in a depth image can include a processor, which can be configured to generate a 3D point cloud using data included in the depth image. The processor can also be configured to receive data related to an orientation of the 3D point cloud. The processor can also be configured to iteratively select at least 3 non-collinear points. The processor can also be configured to iteratively determine whether the at least 3 non-collinear points form a first plane that can be horizontal within a first tolerance and if so: (1) find other points in the first plane, and (2) compare a number of points in the first plane to a number of points in a largest horizontal plane that has already been found.

### TECHNICAL FIELD

The present disclosure relates to sensor data processing, and more particularly, but not by way of limitation, to a method for detecting a ground plane, such as can be used in an autonomous robot.

### BACKGROUND

Sensor data processing can be used to determine information related to information collected by a sensor, which can include using a processor to analyze the sensor data alternatively or in addition to analysis by a human. One source of sensor data can include a time-of-flight (TOF) sensor, such as can generate information related to the distance to objects in the TOF sensor's field-of-view (FOV).

### SUMMARY

In an example, a method for determining a ground plane in a depth image can include generating a 3D point cloud using data included in the depth image. The method can also include receiving data related to an orientation of the 3D point cloud. The method can also include iteratively selecting at least 3 non-collinear points. The method can also include iteratively determining whether the at least 3 non-collinear points form a first plane that can be horizontal within a first tolerance and if so: (1) finding other points in the first plane, and (2) comparing a number of points in the first plane to a number of points in a largest horizontal plane that has already been found.

In an example, a system for determining a ground plane in a depth image can include a processor, which can be configured to generate a 3D point cloud using data included in the depth image. The processor can also be configured to receive data related to an orientation of the 3D point cloud. The processor can also be configured to iteratively select at least 3 non-collinear points. The processor can also be configured to iteratively determine whether the at least 3 non-collinear points form a first plane that can be horizontal within a first tolerance and if so: (1) find other points in the first plane, and (2) compare a number of points in the first plane to a number of points in a largest horizontal plane that has already been found.

In an example, a method for determining a ground plane in a depth image can include generating a 3D point cloud using data included in the depth image, where the depth image can include data received from a time-of-flight sensor. The method can also include discarding points in the 3D point cloud that are located above the time-of-flight sensor. The method can also include receiving data related to an orientation of the 3D point cloud. The method can also include iteratively selecting at least 3 non-collinear points. The method can also include iteratively determining whether the at least 3 non-collinear points form a first plane that can be horizontal within a first tolerance and if so: (1) finding other points in the first plane, (2) comparing a number of points in the first plane to a number of points in a largest horizontal plane that has already been found, (3) selecting the one of the first plane and the largest horizontal plane that has already been found with the largest number of points as a selected plane, and (4) determining whether the found points in the selected plane has horizontal within a second tolerance.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows an example of portions of a system for determining a ground plane in a depth image and an example of portions of an environment in which the system can be used.

FIG. 2A shows an example of portions of a method 200 for determining a ground plane in a depth image.

FIG. 2B shows an example of portions of a method 200 for determining a ground plane in a depth image including a preprocessing stage.

FIG. 2C shows an example of portions of a method 200 for determining a ground plane in a depth image including a detection stage.

FIG. 3 shows an example of portions of a method for determining a ground plane in a depth image.

FIG. 4 is a block diagram of an example of portions of a machine upon which one or more portions of the present disclosure may be implemented.

### DETAILED DESCRIPTION

A ground plane can represent the surface upon which a robot travels, objects are set, or both. For example, the ground plane can represent the floor of a room or the surface of a roadway. Determining the position of a ground or other plane in a TOF image generated by a TOF sensor can be desirable. The determined ground plane can be used in a robotic system (e.g., an autonomous robot), such as to detect obstacles on or near the ground.

The present inventors have recognized, among other things, that determining a position of ground plane can be helped by one or more of preprocessing data before it is used to determine a ground plane, performing one or more checks to determine if a prospective ground plane is horizontal or approximately horizontal, and determining if prospective ground plane is the lowest available plane in a set of data. One or more of these steps can of increase an efficiency of a circuit (e.g., by reducing circuit processing power or processing time), improve a functioning of a circuit (e.g., a processor, a computer) performing the ground plane detection (e.g., by reducing processor load, by decreasing processing time), or both.

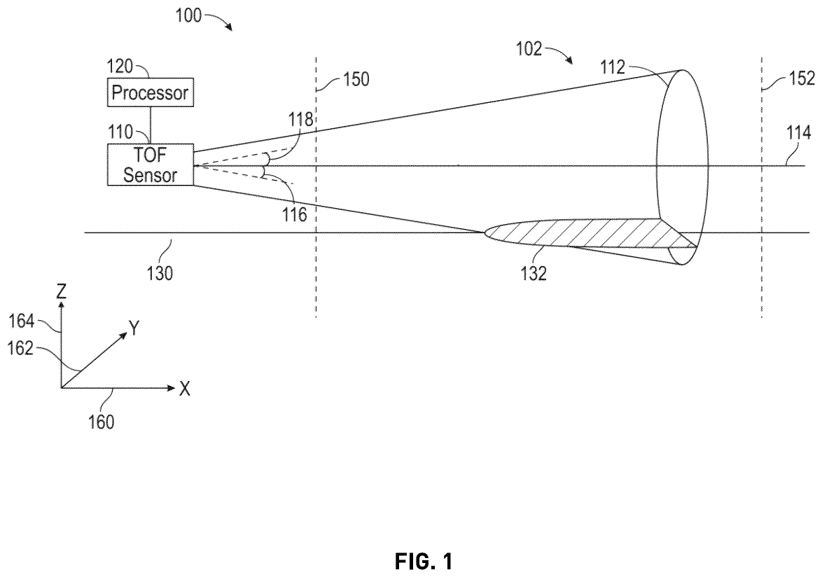

FIG. 1 shows an example of portions of a system 100 for determining a ground plane 132 in a depth image, and an example of portions of an environment 102 in which the system can be used. FIG. 1 shows that the system 100 can include a time-of-flight (TOF) sensor 110, and a processor 120.

The TOF sensor 110 can be configured to generate a depth image. The depth image can include one or more pixels (e.g., a grid of pixels, such as a rectangular grid). One or more of the pixels can include information related to the closest object in a specific angular direction from the TOF sensor. For example, the TOF sensor can scan a field-of-view 112 using a distance measurement system (e.g., using light detection and ranging (LiDAR), using radio detection and ranging (RADAR), using stereo sense, or any other method of obtaining a depth image), and can determine the distance to where the outgoing signal is reflected at a number of points (e.g., pixels) in the field-of-view. The angular coordinates can include a horizontal angle 116 referenced horizontally from the center axis 114 of the TOF sensor 110, and a vertical angle 118 referenced vertically from the center axis 114 of the TOF sensor 110. In an example, the TOF sensor 110 can generate a 512×512 grid of pixels. The depth image can include a three-dimensional image, can be converted to include a three-dimensional image (e.g., converted to a 3D point cloud), or both.

If pixel is greater than a specified maximum range 152 from the TOF sensor 110, the TOF sensor 110 can assign one or more of an error value to that pixel, a maximum value to that pixel (e.g., equal to the value of a pixel at the maximum range), or indicate that the pixel is beyond a maximum range away. If pixel is less than a specified minimum range 150 from the TOF sensor 110 can assign one or more of an error value to that pixel, a minimum value to that pixel (e.g., equal to the value of a pixel at the minimum range), or indicate that the pixel is less than a minimum range away.

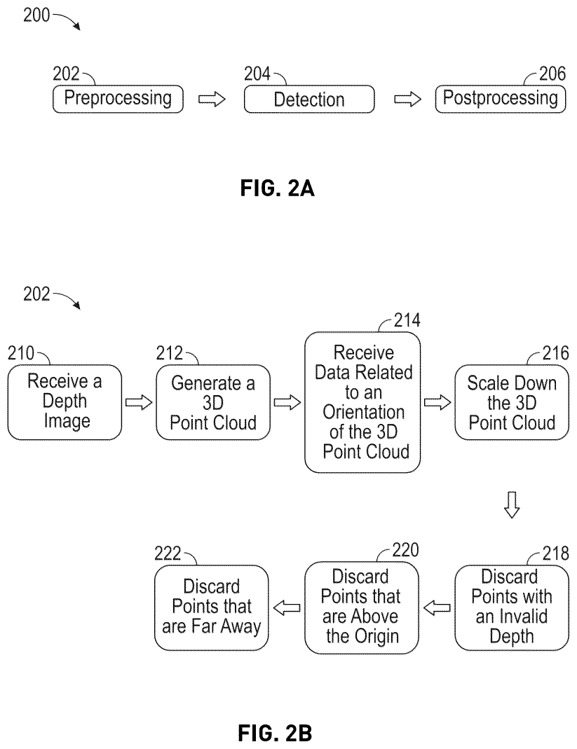

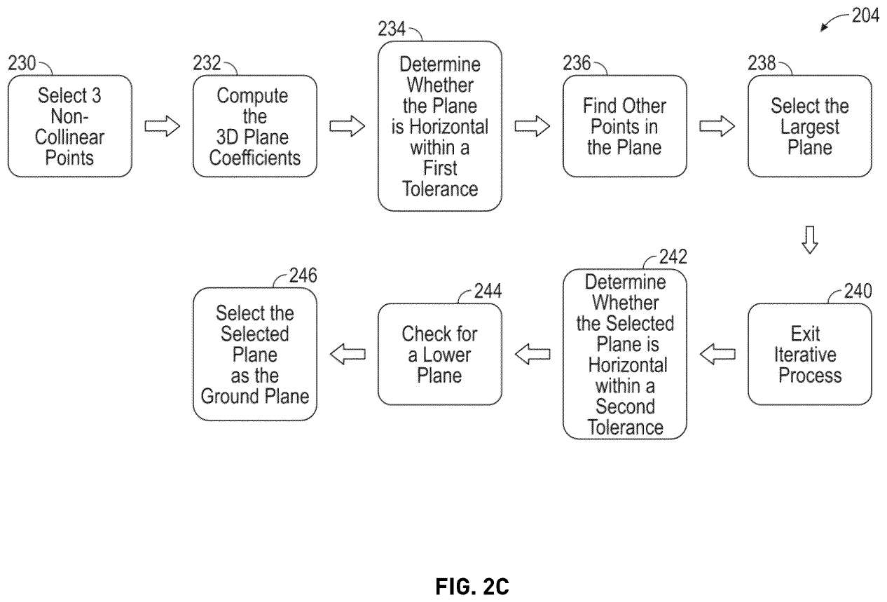

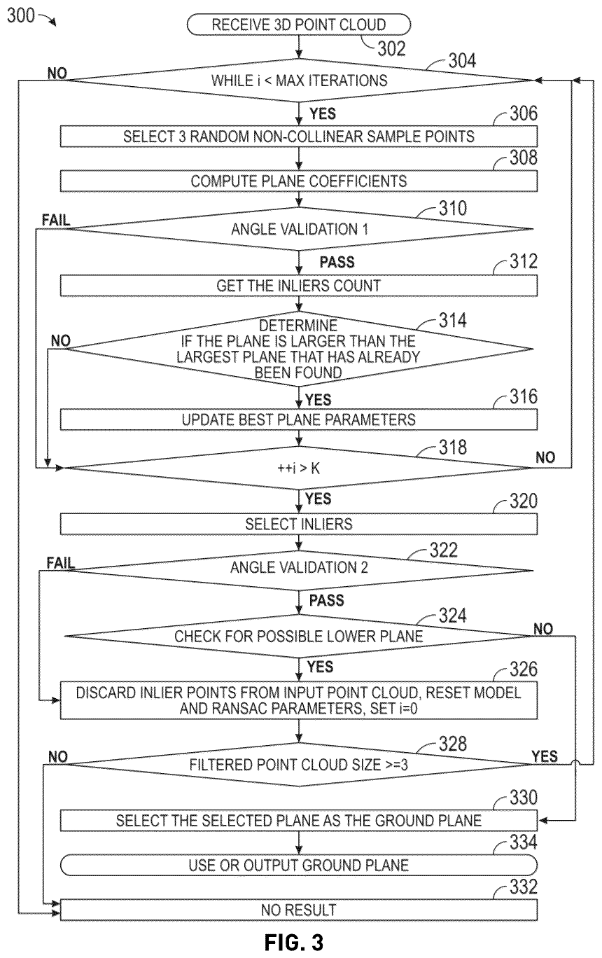

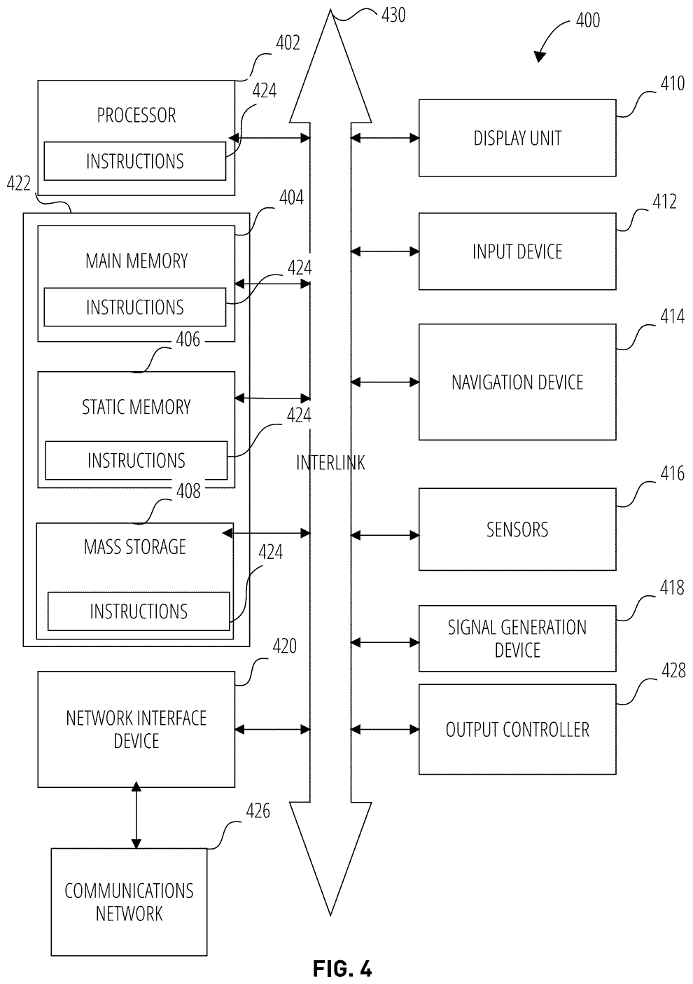

The processor can be any circuit or computer (e.g., as discussed below with respect to FIG. 4) capable of performing operations, such as the operations discussed below (e.g., with respect to FIG. 1, FIG. 2A-C, and FIG. 3). The processor can be configured to determine a ground plane in a depth image, such as can be generated by the TOF sensor 110.

FIG. 1 shows that the environment 102 can be described as having an x-axis 160, a y-axis 162, and a z-axis 164. The x-axis 160 and the y-axis 162 can together form a plane that can be parallel with the ground plane 132. For example, the ground plane 132 can be parallel (e.g., approximately parallel, such as within a specified range) to the level plane of the coordinate system. In an example, the level plane of the coordinate system can be level in that it represents a plane of equal gravitational potential energy (e.g., a level gravitational plane). In an example, the level plane can differ from a level gravitational plane. For example, the level plane can be defined to be parallel to a sloped floor or ground surface.

The ground plane 132 can represent the surface that a robot is travelling on. Determining the level and location of the ground plane 132 can be important in collision free navigation of the robot (e.g., the robot must be able to determine where the ground plane 132 is to determine whether an obstacle or drop off will affect the robot's travel).

FIG. 2A shows an example of portions of a method 200 for determining a ground plane (e.g., the ground plane 132) in a depth image (e.g., such as can be generated by the TOF sensor 110). One or more portions of the method 200 can be performed on a processor, such as the processor 120. FIG. 2A shows that the method 200 can include a preprocessing stage 202, a detection stage 204, and a postprocessing stage 206. The preprocessing stage 202 can include steps to one or more of receive data, generate data, or prepare data for the detection stage 204. The preprocessing stage 202 can be discussed in more detail below with respect to FIG. 2B. The detection stage 204 can include steps to determine the location of a ground plane, such as a ground plane in a depth image. The detection stage 204 can be discussed with more detail below with respect to FIG. 2C and FIG. 3. The postprocessing stage 206 can include steps to one or more of process the ground plane (e.g., the ground plane determined in the detection stage 204) or prepare data generated in prior steps or stages for use by a system, such as use by a robot.

The shown order of steps is not intended to be a limitation on the order in which the steps are performed. In an example, two or more steps may be performed simultaneously or at least partially concurrently.

FIG. 2B shows an example of portions of a method 200 for determining a ground plane in a depth image. FIG. 2B can include steps that may form a portion of the preprocessing stage 202. Alternatively or in addition, one or more steps in FIG. 2B can one or more of form a different portion of the method 200, can be used in another method, or can stand alone.

At step 210, a depth image can be received. For example, a depth image can be received from a TOF sensor, such as the TOF sensor 110. In an example, the depth image can be generated. For example, the depth image can be generated using a TOF sensor included in the system performing the method 200.

At step 212, a three-dimensional (3D) point cloud can be generated, such as based on data included in the depth image received at step 210. The 3D point cloud can include a representation of the depth image that translates each pixel in the depth image to a point (e.g., 3D pixel) in 3D coordinates. For example, one or more pixels from the depth image, such as including distance (e.g., a depth) at a horizontal angle 116 and a vertical angle 118, can be translated to a point in 3D cartesian coordinates, such as can include an x-axis 160 coordinate, a y-axis 162 coordinate, and a z-axis 164 coordinate. The 3D point cloud can have the same number of points as the depth image has pixels (e.g., a one-to-one mapping). Step 212 can include generating a normalized 3D point cloud. For example, the coordinates of the points can be scaled such that a central tendency (e.g., mean, median, mode) of the point cloud coordinates is a specified value.

At step 214, data related to an orientation of the point cloud can be received, generated, or both. For example, an acceleration sensor (e.g., such as included in an inertial measurement unit (IMU)) can determine how a gravitational vector is oriented with respect to the center axis 114 of the TOF sensor 110. This gravitational vector can be used to determine whether the center axis 114 of the TOF sensor 110 is parallel to the ground level 130. Alternatively or additionally, the gravitational vector can be used to determine whether the TOF sensor 110 is level with respect to the y-axis 162 (e.g., whether the horizontal angle 116 is measured in the ground level 130).

In an example, the 3D point cloud can be rotated, such as rotated towards a level orientation (e.g., the center axis 114 and the horizontal angle 116 are parallel to the ground level 130). For example, the 3D point cloud can be generated using the depth image, and then can be rotated so that the 3D point cloud is level with respect to the ground level 130 (e.g., rotating the 3D point cloud towards an upright orientation).

At step 216, the 3D point cloud can be sampled or scaled down (e.g., a number of points in the 3D point cloud can be reduced). For example, a percentage of the points can be removed, such as can include 10 percent, 25 percent, 50 percent, or 75 percent. In an example, the scaling process can include adjusting one or more points, such as through interpolation. In an example, the scaling process may not include adjusting one or more points, and points may either be discarded or kept with unchanged coordinates. In an example, a 512×512 point cloud (e.g., a point cloud generated using a 512×512 depth image) can be scaled down to a 256×256 point cloud. This can include deleting every other one of the rows of points, every other one of the columns of points, or both (e.g., the rows and columns can be based on the original depth image grid (e.g., the angle grid)). In an example, the depth image can be scaled down, alternatively or in addition to scaling down the 3D point cloud.

At step 218, points with an invalid depth can be discarded. This can include discarding points that are one or more of an error value (e.g., due to being too far or too close for the TOF sensor 110 to measure), a specified minimum range 150 value, or a specified maximum range 152 value. In an example, a minimum range, maximum range, or both can be specified that are different from the specified minimum range 150, the specified maximum range 152, or both. For example, the TOF sensor 110 can be configured to measure up to the specified maximum range 152, but the method 200 can include discarding points that are at or greater than a specified processing maximum range, which can be less than the specified maximum range 152.

At step 220, points above the origin can be discarded. The origin can be defined as a point from which the depth image is generated (e.g., the position of the TOF sensor 110). This discarding can include discarding points with a z-axis 164 coordinate greater than, or greater than or equal to, 0. The z-axis 164 coordinate can be determined based on the orientation of the 3D point cloud. For example, the 3D point cloud can be leveled at step 214, and this leveled point cloud can be used to discard points above the origin. In an example, this can include discarding points in the 3D point cloud that are located above the time-of-flight sensor (e.g., the TOF sensor 110). In an example, discarding points in the 3D point cloud that are located above the time-of-flight sensor (e.g., the origin) can occur before selecting at least 3 non-collinear points at step 230.

At step 222, points greater than a specified distance away can be discarded. This step can be performed alternatively or in addition to step 218. In an example, the specified distance can be determined based on a travel speed of a robot, a safety bubble of a robot, or both. In an example, the specified distance can be 2 meters (e.g., the robot can ignore objects on the ground more than 2 meters away). One or more of step 216 through step 222 can reduce a number of points in the point cloud. This reduction in points can one or more of increase an efficiency of a method, such as the detection stage 204, increase a performance of a processor (e.g., a processor implementing the preprocessing stage 202), decrease a length of time that passes while determining a ground plane, or decrease a number of operations used to determine a ground plane. The number of points remaining in the 3D point cloud can be compared to a threshold (e.g., a threshold of 256 points). If the number of remaining points is below the threshold, the method 200 can end without determining a ground plane, such as because the remaining number of points is to small to determine a ground plane (e.g., such as at step 332 discussed below). If the number of remaining points is above the threshold, the method 200 can proceed to attempt to determine a ground plane.

One or more of the steps in the method 200 can reduce a number of points in the 3D point cloud (e.g., steps 216-222). This can include reducing a resolution of a full resolution 3D point cloud to generate the 3D point cloud. In an example, one or more of the steps that reduce a number of points in the 3D point cloud can be performed before selecting 3 non-collinear points at step 230.

The shown order of steps is not intended to be a limitation on the order in which the steps are performed. In an example, two or more steps may be performed simultaneously or at least partially concurrently.

FIG. 2C shows an example of portions of a method 200 for determining a ground plane in a depth image. FIG. 2C can include steps that may form a portion of the detection stage 204. Alternatively or in addition, one or more steps in FIG. 2C can one or more of form a different portion of the method 200, can be used in another method, or can stand alone. In an example, step 230 can follow step 222.

The detection stage 204 can be an iterative stage. For example, one or more of the steps in the detection stage 204 can be performed iteratively until one or more criteria are met to end the iteration. One or more portions of the method 200 can include or be included in an iterative method, such as a random sample consensus (RANSAC).

At step 230, 3 non-collinear sample points can be selected. This can include selecting 3 points from the 3D point cloud at random. In an example, 3 points can be selected, and it can be determined if the points are collinear (e.g., forming a line rather than a plane). If the points are collinear, another 3 points can be selected, which can include one or more of randomly selecting 3 points, or discarding one of the selected points and randomly selecting another point.

At step 232, the 3D plane coefficients of the 3 selected points can be computed. For example, a mathematical description (e.g., an equation) of the plane containing the 3 selected points can be generated. The 3D plane coefficients can be determined from the mathematical description.

At step 234, it can be determined whether the at least 3 non-collinear points form a first plane that is horizontal within a first tolerance. For example, it can be determined whether the first plane is less than a first tolerance (e.g., a specified angular deviation) from the ground level 130. Step 234 can include using the information received at step 214. In an example, the first tolerance can include an inclusive range of between negative 20 degrees on a low end and plus 20 degrees on a high end. If the first plane is not horizontal within the first tolerance, the method 200 can include returning to step 230 to select a different set of points.

At step 236, other points in the first plane can be found. This can include determining the number of points in the 3D point cloud that are within a specified distance from the first plane (e.g., points within 1 inch of the first plane, points within 0.25 inches of the first plane, points within 0.1 inches of the first plane.

At step 238, the number of points in the first plane can be compared to a number of points in a largest horizontal plane that has already been found. For example, the first time one or more of the detection stage 204 steps are iterated (e.g., steps 230-238), there may not be a largest horizontal plane that has already been found (e.g., because the first plane is the first horizontal plane to be found), and the first plane can be larger than the largest horizontal plane that has already been found (e.g., if no plane has been found, the largest horizontal plane that has already been found can have a size of 0 points). After the first time one or more of the detection stage 204 steps are iterated, there can be a largest horizontal plane that has already been found, such as with at least 3 points.

At step 240, the iterative process of the detection stage 204 (e.g., steps 230-238) can be exited (e.g., the iterative process may not continue to be performed, such as before intervening steps are performed). The iterative process can be exited because one or more of the maximum number of iterations has been reached, there are less than a specified number of points in the 3D point cloud (e.g., 3 points), or for another convergence criteria (e.g., number of points in the selected plane is above a threshold, confidence level (e.g., based on ratio of points in the selected plane to points outside of the selected plane)). The number of iterations (e.g., the specified maximum number of iterations) can be determined using a RANSAC iteration equation, which can include one or more of desired probability of success, the probability of selecting a point in the ground plane when a point is selected at random, and a number of points in the ground plane.

At step 242, it can be determined whether the selected plane (e.g., including the found points in the selected plane) are horizontal within a second tolerance. For example, it can be determined whether the selected plane is less than a second tolerance (e.g., a specified angular deviation) from the ground level 130. Step 234 can include using the information received at step 214. The second tolerance can match the first tolerance, or can differ. In an example, the second tolerance can include an inclusive range of between negative 10 degrees on a low end and plus 10 degrees on a high end. Before checking if the selected plane is horizontal within the second tolerance, the 3D plane coefficients of the selected plane can be recomputed based on one or more points in addition to the 3 first selected points (e.g., a better plane fit equation can be determined). If the selected plane is not horizontal within the second tolerance, the method 200 can include one or more of discarding the points in the selected plane (e.g., the found points) or returning to step 230 (e.g., re-entering the iterative process, such as to iteratively search for another ground plane) to select a different set of points and/or find a new selected plane. In an example, if the selected plane is not horizontal within the second tolerance, the method 200 can include discarding all of the points in the selected plane and returning to step 230.

At step 244, a lower plane (e.g., a lower-elevation ground plane) can be checked for. This can include determining a lowest potential plane elevation in the 3D point cloud, such as selecting a lowest vertical coordinate shared by at least a specified number of points. For example, once the 3D point cloud is oriented (e.g., rotated, a rotation is accounted for), the points that represent the lowest elevation can be found. A specified number of points within a specified tolerance (e.g., at least 10 points within 2 inch) can be needed to determine a lowest potential plane elevation. The lowest potential plane elevation can be compared to the elevation of the selected plane. If the selected plane has an elevation higher than the lowest potential plane elevation, the method 200 can include one or more of discarding the points in the selected plane or returning to step 230 to select a different set of points and/or find a new selected plane. In an example, if the selected plane has an elevation higher than the lowest potential plane elevation, the method 200 can include discarding all of the points in the selected plane and returning to step 230.

At step 246, the selected plane can be selected (e.g., determined) as the ground plane. Following determining the ground plane, the determined ground plane can be used by one or more systems, which can include a robotic system.

In an example, the method 200 can include one or more steps following the step 246, such as can form the postprocessing stage 206. Ground pixels in the full resolution 3D point cloud can be selected, such as after determining the ground plane (e.g., at step 246). For example, the 3D point cloud can be scaled down in one or more steps of the method 200 (e.g., steps 216-222), such as to reduce a processing burden. It can be desirable to increase a scale (e.g., resolution) of the 3D point cloud following one or more processing steps. For example, the scale of the 3D point cloud can be returned to the full resolution 3D point cloud following determining the ground plane. This can include determining the 3D plane coefficients of the determined ground plane and finding points in the full resolution 3D point cloud within a specified tolerance of the ground plane. In this example, one or more of no resolution is lost from the full resolution 3D point cloud or no points in the full resolution 3D point cloud are changed. In an example, the reduced resolution 3D point cloud can be scaled up (e.g., using interpolation) to increase a scale of the 3D point cloud.

The shown order of steps is not intended to be a limitation on the order in which the steps are performed. In an example, two or more steps may be performed simultaneously or at least partially concurrently. In an example, one or more steps can be omitted. In an example, the selected plane can be selected as the ground plane, such as at step 246, when the selected plane is determined to be horizontal within the second tolerance, such as at step 242. In this example, step 244 can be omitted.

FIG. 3 shows an example of portions of a method 300 for determining a ground plane in a depth image. One or more portions of the method 300 can include or be included in one or more portions of the method 200. In an example, the method 300 can show an example of flow chart for performing one or more portions of the method 200.

At step 302, a 3D point cloud can be received, such as the point cloud generated at step 222.

At step 304, one or more convergence criteria can be checked, such as discussed above with respect to step 240. For example, a number of iterations (e.g., represented by the iteration count variable i) can be compared to a specified maximum number of iterations.

At step 306 at least 3 non-collinear points can be selected, such as in step 230.

At step 308, the 3D plane coefficients of the selected points (e.g., forming the selected plane) can be determined, such as at step 232.

At step 310, one or more of the operations of step 234 can be completed. If the angle validation fails (e.g., the selected plane is not determined to be horizontal within the first tolerance), the method 300 can include going to step 318. At step 318, the iteration count can be incremented, the method can include returning to step 304, or both. If the angle validation passes, the method 300 can include going to step 312.

At step 312, the other points in the plane can be found and/or counted (e.g., the inliers can be counted), such as at step 236.

At step 314 the selected plane can be compared to a largest horizontal plane that has already been found. Step 314 can include one or more operations of step 238. If the selected plane includes a greater number of points, the method 300 can include going to step 316. If the selected plane has fewer points, the method can include going to step 318.

At step 316, the selected plane can be assigned as the largest horizontal plane that has already been found. This can include recording one or more parameters of the selected plane (e.g., points, 3D plane coefficients).

At step 318, the iteration count variable i can be incremented.

At step 320, the points in the selected plane (e.g., the largest horizontal plane that was found in steps 306-316) can be selected. This can include determining new 3D plane coefficients, such as is discussed with respect to step 242.

At step 322, one or more operations of step 242 can be completed. If the angle validation fails (e.g., the selected plane is not determined to be horizontal within the second tolerance), the method 300 can include going to step 326. If the angle validation passes, the method 300 can include going to step 324. In an example, the method can go directly to step 330 after step 322.

At step 324, one or more operations of step 244 can be completed. If the selected plane has a higher elevation than the lowest potential plane elevation, the method 300 can include going to step 326. If the selected plane has a lower elevation than a lowest potential plane elevation, the method can include going to step 330.

At step 326, one or more of (1) the points in the selected plane can be discarded, (2) the iterative model can be reset (e.g., discarding the largest plane that has already been found), or (3) the iteration count can be set to 0.

At step 328, a number of points in the point cloud (e.g., points that are left after the removal of points in various steps) can be compared to a threshold value (e.g., a threshold value of 3). If the number of points is greater than or equal to the threshold, the method 300 can include returning to step 304. If the number of points is less than the threshold, the method 300 can include going to step 332.

In an example, step 328 can also include incrementing a iteration count variable j, and comparing this variable to a specified threshold number of iterations of the RANSAC loop (e.g., steps 304 through 318). If the maximum number of iterations is exceeded, the method 300 can include going to step 332.

At step 330, the selected plane can be selected as the ground plane, such as at step 246. One or more of the 3D plane coefficients can be updated.

At step 332, the method 300 can determine that no ground plane can be found. This an include being unable to find a ground plane within a specified certainty level.

At step 334, the ground plane can be one or more of used or output to another system.

The shown order of steps is not intended to be a limitation on the order in which the steps are performed. In an example, two or more steps may be performed simultaneously or at least partially concurrently.

FIG. 4 illustrates a block diagram of an example machine 400 upon which any one or more of the techniques (e.g., methodologies) discussed herein may be implemented. Examples, as described herein, may include, or may operate by, logic or a number of components, or mechanisms in the machine 400. Circuitry (e.g., processing circuitry) is a collection of circuits implemented in tangible entities of the machine 400 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 400 follow.

In alternative examples, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 400 may include a hardware processor 402 (e.g., a central processing unit (CPU), a graphics processing unit (GPU), a hardware processor core, or any combination thereof), a main memory 404, a static memory (e.g., memory or storage for firmware, microcode, a basic-input-output (BIOS), and mass storage 408 (e.g., hard drives, tape drives, flash storage, or other block devices) some or all of which may communicate with each other via an interlink 430 (e.g., bus). The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a signal generation device 418 (e.g., a speaker), a network interface device 420, and one or more sensors 416, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 402, the main memory 404, the static memory 406, or the mass storage 408 may be, or include, a machine readable medium 422 on which is stored one or more sets of data structures or instructions 424 (e.g., software) embodying or utilized by any one or more of the techniques or functions described herein. The instructions 424 may also reside, completely or at least partially, within any of registers of the processor 402, the main memory 404, the static memory 406, or the mass storage 408 during execution thereof by the machine 400. In an example, one or any combination of the hardware processor 402, the main memory 404, the static memory 406, or the mass storage 408 may constitute the machine readable media 422. While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 422 may be representative of the instructions 424, such as instructions 424 themselves or a format from which the instructions 424 may be derived. This format from which the instructions 424 may be derived may include source code, encoded instructions (e.g., in compressed or encrypted form), packaged instructions (e.g., split into multiple packages), or the like. The information representative of the instructions 424 in the machine readable medium 422 may be processed by processing circuitry into the instructions to implement any of the operations discussed herein. For example, deriving the instructions 424 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 424.

In an example, the derivation of the instructions 424 may include assembly, compilation, or interpretation of the information (e.g., by the processing circuitry) to create the instructions 424 from some intermediate or preprocessed format provided by the machine readable medium 422. The information, when provided in multiple parts, may be combined, unpacked, and modified to create the instructions 424. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 424 may be further transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software. A transmission medium is a machine-readable medium.

The following, non-limiting examples, detail certain aspects of the present subject matter to solve the challenges and provide the benefits discussed herein, among others.

### EXAMPLES

Example 1 is a method for determining a ground plane in a depth image, the method comprising: generating a 3D point cloud using data included in the depth image; receiving data related to an orientation of the 3D point cloud; iteratively: selecting at least 3 non-collinear points; determining whether the at least 3 non-collinear points form a first plane that is horizontal within a first tolerance and if so: finding other points in the first plane; and comparing a number of points in the first plane to a number of points in a largest horizontal plane that has already been found.

In Example 2, the subject matter of Example 1 optionally includes selecting the one of the first plane and the largest horizontal plane that has already been found with the largest number of points as a selected plane.

In Example 3, the subject matter of Example 2 optionally includes determining whether the found points in the selected plane are horizontal within a second tolerance.

In Example 4, the subject matter of Example 3 optionally includes checking for a lower plane, including: determining a lowest potential plane elevation in the 3D point cloud by selecting a lowest vertical coordinate shared by at least a specified number of points; and comparing the lowest potential plane elevation to an elevation of the selected plane.

In Example 5, the subject matter of any one or more of Examples 3-4 optionally include selecting the selected plane as the ground plane when the selected plane is determined to be horizontal within the second tolerance.

In Example 6, the subject matter of Example 5 optionally includes discarding the found points in the selected plane when the selected plane is determined to not be horizontal within the second tolerance; and iteratively searching for another ground plane.

In Example 7, the subject matter of Example 6 optionally includes determining that no ground plane can be found if there are less than 3 non-discarded points in the 3D point cloud.

In Example 8, the subject matter of any one or more of Examples 3-7 optionally include wherein: the first tolerance includes an inclusive range of between negative 20 degrees on a low end and plus 20 degrees on a high end; and the second tolerance includes an inclusive range of between negative 10 degrees on a low end and plus 10 degrees on a high end.

In Example 9, the subject matter of any one or more of Examples 1-8 optionally include wherein: the depth image includes data received from a time-of-flight sensor.

In Example 10, the subject matter of Example 9 optionally includes discarding points in the 3D point cloud that are located above the time-of-flight sensor.

In Example 11, the subject matter of Example 10 optionally includes wherein: discarding points in the 3D point cloud that are located above the time-of-flight sensor occurs before selecting at least 3 non-collinear points.

In Example 12, the subject matter of any one or more of Examples 1-11 optionally include wherein: receiving data related to an orientation of the 3D point cloud includes rotating the 3D point cloud towards an upright orientation.

In Example 13, the subject matter of any one or more of Examples 1-12 optionally include reducing a resolution of a full resolution 3D point cloud to generate the 3D point cloud before selecting 3 non-collinear points; and selecting ground pixels in the full resolution 3D point cloud after determining the ground plane.

In Example 14, the subject matter of Example 13 optionally includes removing invalid points in the 3D point cloud before selecting 3 non-collinear points; and removing points in the 3D point cloud beyond a specified depth before selecting 3 non-collinear points.

In Example 15, the subject matter of any one or more of Examples 1-14 optionally include wherein: determining whether the at least 3 non-collinear points form the first plane that is horizontal within a first tolerance includes determining 3D plane coefficients of the first plane.

Example 16 is a system for determining a ground plane in a depth image, the system comprising: a processor, configured to: generate a 3D point cloud using data included in the depth image; receive data related to an orientation of the 3D point cloud; iteratively: select at least 3 non-collinear points; determine whether the at least 3 non-collinear points form a first plane that is horizontal within a first tolerance and if so: find other points in the first plane; and compare a number of points in the first plane to a number of points in a largest horizontal plane that has already been found.

In Example 17, the subject matter of Example 16 optionally includes wherein the processor is configured to: select the one of the first plane and the largest horizontal plane that has already been found with the largest number of points as a selected plane; and determine whether the found points in the selected plane are horizontal within a second tolerance.

In Example 18, the subject matter of Example 17 optionally includes wherein the processor is configured to: discard the found points in the selected plane when the selected plane is determined to not be horizontal within the second tolerance; and iteratively search for another ground plane.

In Example 19, the subject matter of any one or more of Examples 16-18 optionally include a time-of-flight sensor, configured to generate the depth image.

Example 20 is a method for determining a ground plane in a depth image, the method comprising: generating a 3D point cloud using data included in the depth image, wherein the depth image includes data received from a time-of-flight sensor; discarding points in the 3D point cloud that are located above the time-of-flight sensor; receiving data related to an orientation of the 3D point cloud; iteratively: selecting at least 3 non-collinear points; determining whether the at least 3 non-collinear points form a first plane that is horizontal within a first tolerance and if so: finding other points in the first plane; comparing a number of points in the first plane to a number of points in a largest horizontal plane that has already been found; selecting the one of the first plane and the largest horizontal plane that has already been found with the largest number of points as a selected plane; and determining whether the found points in the selected plane are horizontal within a second tolerance.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the terms “or” and “and/or” are used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A method for determining a ground plane in a depth image, the method comprising:
generating a 3D point cloud using data included in the depth image;
receiving data related to an orientation of the 3D point cloud;
iteratively:
selecting at least 3 non-collinear points;
determining whether the at least 3 non-collinear points form a first plane that is horizontal within a first tolerance and if so:
finding other points in the first plane; and
comparing a number of points in the first plane to a number of points in a largest horizontal plane that has already been found.

2. The method of claim 1, comprising:
selecting the one of the first plane and the largest horizontal plane that has already been found with the largest number of points as a selected plane.

3. The method of claim 2, comprising:
determining whether the found points in the selected plane are horizontal within a second tolerance.

4. The method of claim 3, comprising:
checking for a lower plane, including:
determining a lowest potential plane elevation in the 3D point cloud by selecting a lowest vertical coordinate shared by at least a specified number of points; and
comparing the lowest potential plane elevation to an elevation of the selected plane.

5. The method of claim 3, comprising:
selecting the selected plane as the ground plane when the selected plane is determined to be horizontal within the second tolerance.

6. The method of claim 5, comprising:
discarding the found points in the selected plane when the selected plane is determined to not be horizontal within the second tolerance; and
iteratively searching for another ground plane.

7. The method of claim 6, comprising:
determining that no ground plane can be found if there are less than 3 non-discarded points in the 3D point cloud.

8. The method of claim 3, wherein:
the first tolerance includes an inclusive range of between negative 20 degrees on a low end and plus 20 degrees on a high end; and
the second tolerance includes an inclusive range of between negative 10 degrees on a low end and plus 10 degrees on a high end.

9. The method of claim 1, wherein:
the depth image includes data received from a time-of-flight sensor.

10. The method of claim 9, comprising:
discarding points in the 3D point cloud that are located above the time-of-flight sensor.

11. The method of claim 10, wherein:
discarding points in the 3D point cloud that are located above the time-of-flight sensor occurs before selecting at least 3 non-collinear points.

12. The method of claim 1, wherein:
receiving data related to an orientation of the 3D point cloud includes rotating the 3D point cloud towards an upright orientation.

13. The method of claim 1, comprising:
reducing a resolution of a full resolution 3D point cloud to generate the 3D point cloud before selecting 3 non-collinear points; and
selecting ground pixels in at least one of the full resolution 3D point cloud or the depth image after determining the ground plane.

14. The method of claim 13, comprising:
removing invalid points in the 3D point cloud before selecting 3 non-collinear points; and
removing points in the 3D point cloud beyond a specified depth before selecting 3 non-collinear points.

15. The method of claim 1, wherein:
determining whether the at least 3 non-collinear points form the first plane that is horizontal within a first tolerance includes determining 3D plane coefficients of the first plane.

16. A system for determining a ground plane in a depth image, the system comprising:
a processor, configured to:
generate a 3D point cloud using data included in the depth image;
receive data related to an orientation of the 3D point cloud;
iteratively:
select at least 3 non-collinear points;
determine whether the at least 3 non-collinear points form a first plane that is horizontal within a first tolerance and if so:
find other points in the first plane; and
compare a number of points in the first plane to a number of points in a largest horizontal plane that has already been found.

17. The system of claim 16, wherein the processor is configured to:
select the one of the first plane and the largest horizontal plane that has already been found with the largest number of points as a selected plane; and
determine whether the found points in the selected plane are horizontal within a second tolerance.

18. The system of claim 17, wherein the processor is configured to:
discard the found points in the selected plane when the selected plane is determined to not be horizontal within the second tolerance; and
iteratively search for another ground plane.

19. The system of claim 16, comprising:
a time-of-flight sensor, configured to generate the depth image.

20. A method for determining a ground plane in a depth image, the method comprising:
generating a 3D point cloud using data included in the depth image, wherein the depth image includes data received from a time-of-flight sensor;
discarding points in the 3D point cloud that are located above the time-of-flight sensor;
receiving data related to an orientation of the 3D point cloud;
iteratively:
selecting at least 3 non-collinear points;
determining whether the at least 3 non-collinear points form a first plane that is horizontal within a first tolerance and if so:
finding other points in the first plane;
comparing a number of points in the first plane to a number of points in a largest horizontal plane that has already been found;
selecting the one of the first plane and the largest horizontal plane that has already been found with the largest number of points as a selected plane; and
determining whether the found points in the selected plane are horizontal within a second tolerance.
